(19) United States
(12) Patent Application Publication
(10) Pub. No.: US 2022/0401962 A1
(43) Pub. Date: Dec. 22, 2022

(54) SYSTEMS AND METHODS FOR SECURE DISPOSAL AND REMOVAL OF PRINTING RIBBON

(71) Applicant: Capital One Services, LLC, McLean, VA (US)

(72) Inventor: Brian DOTSON, McLean, VA (US)

(21) Appl. No.: 17/351,522

(22) Filed: Jun. 18, 2021

(51) Int. Cl. B02C 25/00; B02C 18/00; B65F 1/00

(52) U.S. Cl. CPC B02C 25/00; B02C 18/0007; B65F 1/00; B02C 2018/0015; B65F 2210/1443; B65F 2210/169

(57) ABSTRACT

Systems and methods for secure card printing ribbon removal may include a shredding unit, a collection unit, and a processor. The shredding unit may shred card printing ribbon and generate ribbon waste. The collection unit may be removably attached to the shredding unit and receive ribbon waste from the shredding unit. The collection unit may comprise a transparent material, a visual fill line, and a sensor that determines the amount of ribbon waste contained in the collection unit. Upon determination that the amount of ribbon waste exceeds a threshold, the sensor may generate a signal. The processor may operate the shredding unit and the collection unit, receive the signal generated by the collection unit, and generate, based on the signal, a prediction of a remaining capacity of the collection unit. The ribbon may include material containing sensitive information.

### FIELD OF THE DISCLOSURE

The present disclosure relates to systems and methods for printing using ribbon, and more specifically, for the secure removal of printing ribbon.

### BACKGROUND

Ribbon-based printing is a common method of embellishing embossed characters (a process known as “tipping”) or otherwise printing information directly onto a substrate. These methods are frequently used to print information on cards and other printable materials. Cards, and other printed materials are increasingly prevalent in all aspects of society. Cards, such as credit cards and debit cards, for example, may be involved in commercial and other transactions, such as purchases and other financial transactions, as well as for non-financial activity. These transactions may often involve sensitive accounts or data, including financial accounts and balances, access to funds, funds transfers, and purchases or sales of goods and services. For example, electronic transactions often require the use of private information, and as electronic transactions become an increasingly large share of commercial activity, data security risks also increase.

The demand for cards is increasing with their use, and accordingly an increasing number of cards are being printed and/or embossed. Printing information on a card for use thereafter and disposing the used print material implicates a variety of security concerns, such as the potential for misuse or unauthorized access. For example, if material used for printing, such as a printing ribbon, is not promptly and securely disposed of after use, sensitive information could be exposed. In addition, machines for cutting and disposing print material that are located in different areas make it challenging to implement adequate security precautions. Moreover, where desktop card personalization equipment is employed outside of a highly-secured location, such as in the public space of a retail store or at a remote pop-up locale, theft is always a risk and the loss of equipment with enclosed printer ribbon containing sensitive, non-public information may compromise both the issuing entity and the end customer.

These and other deficiencies exist. It is therefore critical to efficiently and securely remove and dispose of print material.

### SUMMARY OF THE DISCLOSURE

Embodiments of the present disclosure provide a secure card printing ribbon removal system. The system may include a shredding unit, a collection unit, and a processor. The shredding unit may shred card printing ribbon and generate ribbon waste. The collection unit may be removably attached to the shredding unit and receive ribbon waste from the shredding unit. The collection unit may comprise a transparent material, a visual fill line, and a sensor that determines the amount of ribbon waste contained in the collection unit. Upon determination that the amount of ribbon waste exceeds a threshold, the sensor may generate a signal. The processor may operate the shredding unit and the collection unit, receive the signal generated by the collection unit, and generate, based on the signal, a prediction of a remaining capacity of the collection unit. The ribbon may include material containing sensitive information.

Embodiments of the present disclosure provide a method of secure card printing ribbon removal. The method may include receiving ribbon, wherein the ribbon comprises material including sensitive information associated with one or more card printing methods. The method may include shredding the ribbon to generate ribbon waste. The method may include transferring the ribbon waste from a shredding unit to a collection unit. The method may include determining an amount of ribbon waste. The method may include generating, based on the determined amount of ribbon waste, one or more predictions, the one or more predictions indicative of when to empty the collection unit.

Embodiments of the present disclosure provide a non-transitory computer-accessible medium having stored thereon computer-executable instructions, wherein upon execution by a processor, the instructions cause the processor to perform procedures comprising: receiving ribbon; shredding the ribbon to generate ribbon waste, wherein the ribbon waste comprises material including sensitive information associated with one or more card printing methods; transferring the ribbon waste from a shredding unit to a collection unit; determining an amount of ribbon waste; and generating, based on the determined amount of ribbon waste, one or more predictions, the one or more predictions indicative of when to empty the collection unit.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts a secure card printing ribbon removal system according to an exemplary embodiment.

FIG. 2A is an illustration of a card according to an exemplary embodiment.

FIG. 2B is an illustration of a contact pad of a card according to an exemplary embodiment.

FIG. 2C is an illustration of a card according to an exemplary embodiment.

FIG. 3 depicts a method of secure card printing ribbon removal according to an exemplary embodiment.

FIG. 4 depicts an apparatus according to an exemplary embodiment.

FIG. 5 depicts an apparatus according to an exemplary embodiment.

FIG. 6 depicts a method of secure card printing ribbon removal according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present disclosure provides a systems and methods for printing using ribbon, and for the secure removal of used printing ribbon. Exemplary embodiments include use of a shredding unit to shred used printing ribbon and generate ribbon waste, a collection unit to receive the ribbon waste from the shredding unit, and a processor. The collection unit may comprise a transparent material, a visual fill line, and a sensor that determines the amount of ribbon waste contained in the collection unit. Upon determination that the amount of ribbon waste exceeds a threshold, the sensor may generate a signal. The processor may operate the shredding unit and the collection unit, receive the signal generated by the collection unit, and generate, based on the signal, a prediction of a remaining capacity of the collection unit. The ribbon may comprise material containing sensitive information that is to be kept secure and protected from inadvertent or unauthorized disclosure.

Benefits of the systems and methods disclosed herein include improved prediction generation and secure ribbon destruction and waste handling. Machines for printing or disposing printing ribbon information are typically located in a secure location, such as a secure storage locker, behind secure doors, or locked inside a room, in order to protect sensitive information. Given the secure location, access to these machines is limited, but necessary access to the machines includes removing waste from used ribbon, changing machine configurations, and performing maintenance. Once the ribbon has been used, it may be shredded since it contains sensitive information. Leaving the unshredded ribbon waste with sensitive information leads to security vulnerabilities, and inadvertent or unauthorized access to or usage of this waste can lead to disclosure of sensitive information as well as theft and fraud. Systems and methods disclosed herein provide for a secure way to dispose of the used ribbon and safely store the ribbon waste, while reducing the involvement of authorized employees or other personnel in these process, and while reducing the opportunities for unauthorized individuals to deliberately or inadvertently have access to the system or the ribbon and the sensitive information it contains. By generating predictions, the removal of the ribbon waste from the collection unit can be anticipated and planned for, which further promotes security, protects the sensitive information, and reduces the opportunities for unauthorized access to the system or the ribbon.

Additionally, by shredding and then collecting the used ribbon inside the machine, issues associated with opening the machine for separate ribbon disposal, such as the introduction and collection of dust or other contaminating particles, are avoided. In addition, the lifespan of the machine is increased since there would be reduced or minimal need to periodically continue accessing and opening the machine for servicing to remove the ribbon waste for shredding and disposal, thereby leading in reduced maintenance costs, greater savings, and improved efficiency for the machine. A secure housing of the machine need not be opened in order to remove, empty and return the collection unit to its runtime position.

In addition, dual control security procedures limit the transportation, installation, and removal of certain supplies within the machine, and the systems and methods described herein avoid this issue as well. For example, the systems and methods disclosed herein promote the mobility of card printing, allowing card printing to be done at sites other than secure locations, such as commercial or retail locations, and pop-up locations for particular events, such as sports, concerts, fairs, or festivals, where consumers are gathering.

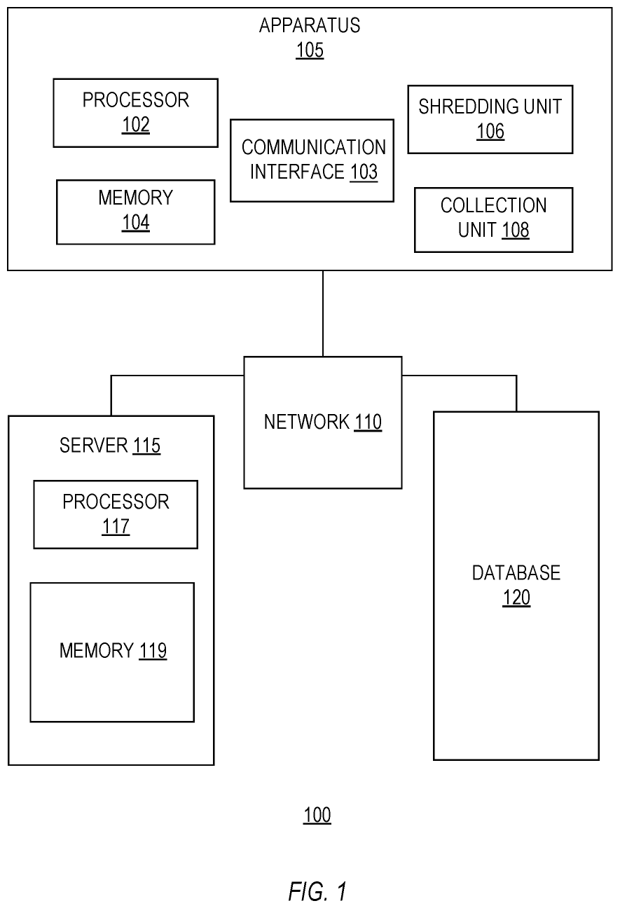

FIG. 1 illustrates a secure card printing removal system 100. The secure card printing ribbon removal system 100 may comprise an apparatus 105, a network 110, a server 115, and a database 120.

The apparatus 105 may include a processor 102, a communication interface 103, a memory 104, a shredding unit 106, and a second unit 108. The communication interface 103 may comprise communication capabilities with physical interfaces and contactless interfaces. For example, the communication interface 103 may be configured to communicate with a physical interface, such as by swiping through a card swipe interface or inserting into a card chip reader found on an automated teller machine (ATM) or other device configured to communicate over a physical interface. In other examples, the communication interface 103 may be configured to establish contactless communication with a card reading device via a short-range wireless communication method, such as NFC, Bluetooth, Wi-Fi, RFID, and other forms of contactless communication. As shown in FIG. 1, the communication interface 103 may be configured to communicate directly with any component of apparatus 105 and/or any component of system 100. In some examples, the communication interface 103 may include a display interface for displaying any information received from any component of apparatus 105 and/or any component of system 100.

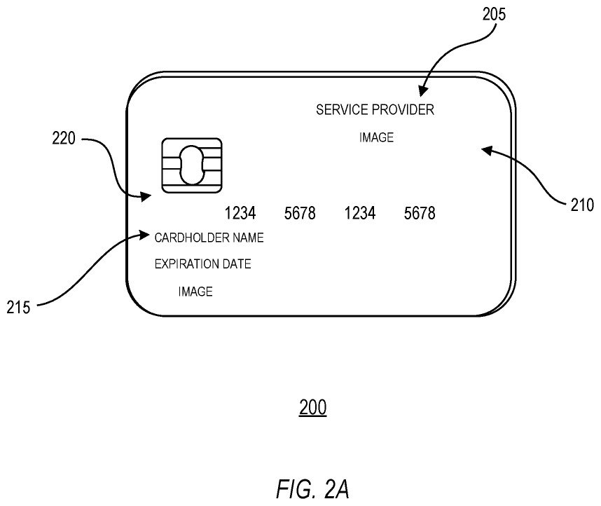

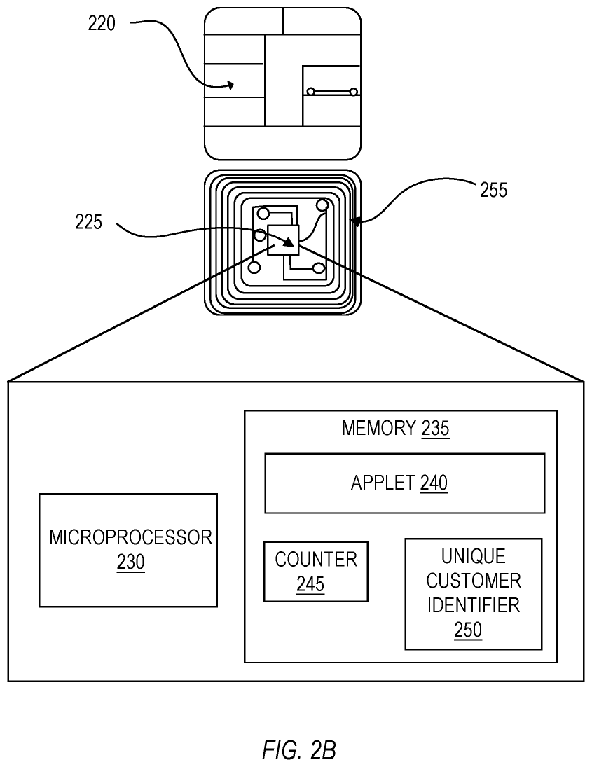

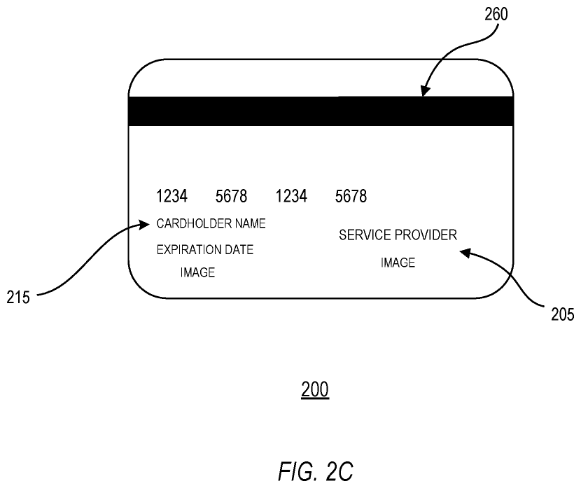

The shredding unit 106 may comprise a micro-shredder. The micro-shredder may be compliant with, for example, shredding security level DIN Level-P5 or higher, in relation to the size of the shredder particles. The shredding unit 106 may be configured to shred card printing ribbon and generate ribbon waste. The card printing ribbon may comprise material including sensitive information. The sensitive information may comprise non-public personal information such as, but not limited to, account number, date of birth, name information, expiration date, identifiers, and the like. Without limitation, the card may comprise an identification card, a temporary or permanent access card, a security card, a gift card, a debit card, a credit card, prepaid cards, insurance cards, as explained below with respect to FIGS. 2A and 2B. In some examples, the shredding unit 106 may be configured to receive the card printing ribbon via one or more spools. The one or more spools may be configured to convey the card printing ribbon via a belt to the shredding unit 106. The one or more spools may be configured to convey the card printing ribbon via a set of rollers to the shredding unit 106, which may include, by way of example, one or more spring-loaded tensioners or tractor feed pins.

The shredding unit 106 may be configured to shred this material only after the ribbon has been fully utilized. In other examples, the shredding unit 106 may be configured to shred the card printing ribbon after it has been partially utilized. The card printing ribbon may be shredded by the shredding unit 106 such that the remainder particles are small enough and compliant with rules governing the shredding size. It is understood that different types of printing methods may be applicable to the card, including but not limited to dye sublimation and thermal transfer printing.

The shredding unit 106 may further comprise a latch. The latch may include a spring-loaded latch that is disposed in one or more positions based on the second unit 108. For example, the latch may, upon removal of the collection unit, close. In another example, the latch may, upon re-attachment of the collection unit to the shredding unit 106, open. The latch may be controlled by the processor and may be configured to close and open in response to instructions from the processor.

The collection unit 108 may be attached to the shredding unit 106. In some examples, the collection unit 108 may be positioned under the shredding unit 106. In addition, the collection unit 108 may be coupled to the shredding unit 106 and is separate from the apparatus 105. In some examples, the collection unit 108 may be engaged to the shredding unit 106. In other examples, the collection unit 108 may be sealed to the shredding unit 106. For example, the removal of the collection unit 108 does not require opening up the apparatus 105 for access. The collection unit 108 may be removably attached to the shredding unit 106 via the latch, as previously described. In some examples, the collection unit 108 may include a handle coupled thereto so as to assist in removal from an apparatus 105. The collection unit 108 may be configured to receive the ribbon waste from the shredding unit 106. The collection unit 108 may include a transparent material. Without limitation, the transparent material may include glass, plastic, and/or any combination thereof.

The collection unit 108 may also include one or more fill lines. For example, the one or more fill lines may include one or more visual fill lines. Without limitation, the visual fill line may be associated with any character, image, identifier, symbol, number, and/or any combination thereof for any range. For example, the visual line may comprise a first line indicating “half” for halfway capacity of the collection unit 108, and a second line indicating “full” for full capacity of the collection unit 108. In another example, the visual line may comprise a first line indicating “33%”, a second line indicating “66%”, and a third line indicating “100%”. In another example, the visual line may comprise a line indicating “F” for full capacity of the collection unit 108. In some examples, one or more fill lines may correspond to one or more types of ribbon. For example, a first set of fill lines may refer to a ribbon having a first size, and a second set of fill lines may refer to a ribbon having a second size, to account for differences in volumes of the shredded ribbon waste.

The collection unit 108 may be further include a sensor. In some examples, the sensor may be configured to determine the amount of ribbon waste contained in the collection unit 108. The sensor may be configured to determine that the amount of ribbon waste exceeds a threshold amount. For example, the threshold amount may be controlled by the processor. In some examples, the threshold amount may correspond to the visual fill line. Upon determination that the amount of ribbon waste exceeds the threshold amount, the sensor may be configured to generate one or more signals. For example, at least one of the signals may indicate the amount of ribbon waste. The signal may further indicate when to remove the second unit 108. For example, the signal may further indicate, upon the ribbon waste reaching the visual fill line of the collection unit 108, removal of the collection unit 108 to empty the ribbon waste. The sensor may be configured to determine a fill level in collection unit 108 based on weight of the ribbon waste. When the collection unit 108 is full, the signal may trigger an alert via an interface, such as communication interface 103 on an apparatus 105. The apparatus 105 may be configured to enter a non-operational or inactive state in which the collection unit 108 must be emptied and sensor reset prior to resuming or continuing normal operation. Moreover, when using remote management software, the alert to empty the collection unit 108 may also be presented on dashboard reporting.

The shredding unit 106 and the second unit 108 may share a source. Without limitation, the shredding unit 106 and the collection unit 108 may share a source, such as common power supply. For example, the first and second units 106, 108 may use the central power supply of an apparatus. In another example, the first and second units 106, 108 may use their own batteries for operation.

In addition, the shredding unit 106 and the collection unit 108 may be securely housed in an apparatus 105. For example, the apparatus 105 may comprise a printer apparatus that is configured to print information onto a card. In another example, the apparatus 105 may comprise an embosser that is configured to emboss information onto a card and embellish the embossed information with a colored or metallic foil via tipping. In yet another example, the apparatus 105 may comprise a printer and an embosser that are integrated therein and configured to perform these functions.

The processor 102 may be configured to control the shredding unit 106 and/or the second unit 108. In some examples, the processor 102 may be configured to operate the shredding unit 106 and the collection unit 108. The processor 102 may thus be in data communication with the sensor of the second unit 108. The processor 102 may be configured to receive the one or more signals generated by the sensor of the collection unit 108. Based on the received signal, the processor 102 may be configured to generate a prediction of a remaining capacity of the collection unit 108. For example, the remaining capacity may comprise the amount of remaining ribbon waste in the collection unit 108 as determined by the processor 102. In some examples, the processor 102 may be configured to activate the latch based on the one or more signals. For example, the processor 102 may be configured to disengage the latch when the signal indicates the remaining capacity of the collection unit 108 has met or exceeded a predetermined threshold amount of ribbon waste. In this manner, the collection unit 108 may be automatically unsecured by the processor 102. In another example, the processor 102 may be configured to re-engage the latch when the collection unit 108 has been emptied after having met or exceeded a predetermined threshold amount of ribbon waste, and the collection unit 108 is brought back to the apparatus for re-attachment. In this manner, the collection unit 108 may be automatically secured by the processor 102.

The processor 102 may be configured to monitor the amount of waste. For example, the processor 102 may be configured to monitor an amount of ribbon waste in the collection unit 108. The processor 102 may be configured to periodically obtain measurements from the sensor at a predetermined time or schedule. Based on the monitored amount, the processor 102 may be configured to generate one or more predictions on when to empty the collection unit 108. For example, the processor 102 may be configured to generate a prediction based on one or more variables. Without limitation, the one or more variables may include the amount of time the apparatus 105 has been operating, such as the amount of time the shredding unit 106 has been shredding the card ribbon and/or the amount of time the collection unit 108 has been accumulating the card ribbon waste; the type of card ribbon; the anticipated workload of card ribbon; the amount of unused ribbon remaining on one or more spools; the number of cards processed against one or more spools of ribbon; a desired frequency of shredding; a desired frequency of disposal; the type of ribbon currently being used; one or more types of ribbon previously used; one or more types of ribbons anticipated or planned to be used; and/or any combination thereof.

The one or more predictions by the processor 102 may be developed by one or more machine learning algorithms and generated by the application of by one or more predictive models. In an embodiment, the machine learning algorithms employed can include at least one selected from the group of gradient boosting machine, logistic regression, neural networks, and a combination thereof, however, it is understood that other machine learning algorithms can be utilized.

For example, to generate predictions, one or more predictive models may utilize information relating to the variables described above, including without limitation: the amount of time the apparatus 105 has been operating; the amount of time the shredding unit 106 has been shredding the card ribbon; the amount of time the collection unit 108 has been accumulating the card ribbon waste; the type of card ribbon; the anticipated workload of card ribbon; the amount of unused ribbon remaining on one or more spools; the number of cards processed against one or more spools of ribbon; a desired frequency of shredding; a desired frequency of disposal; the type of ribbon currently being used; one or more types of ribbon previously used; and one or more types of ribbons anticipated or planned to be used.

The predictive models described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units.

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real-valued weight. Nodes may either be (i) input nodes (e.g., receiving data from outside the network), (ii) output nodes (e.g., yielding results), or (iii) hidden nodes (e.g., that may modify the data en route from input to output). RNNs may accept an input vector x and give an output vector y. However, the output vectors are based not only by the input just provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The predictive models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems.

In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

System 100 may include a network 110. In some examples, network 110 may be one or more of a wireless network, a wired network or any combination of wireless network and wired network, and may be configured to connect to any one of components of system 100. In some examples, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 110 may include, without limitation, telephone lines, fiber optics, IEEE Ethernet 902.3, a wide area network, a wireless personal area network, a LAN, or a global network such as the Internet. In addition, network 110 may support an Internet network, a wireless communication network, a cellular network, or the like, or any combination thereof. Network 110 may further include one network, or any number of the exemplary types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more examples, network 110 may comprise a plurality of interconnected networks, such as, for example, the Internet, a service provider's network, a cable television network, corporate networks, such as credit card association networks, and home networks.

System 100 may further comprise one or more servers 115. In some examples, the server 115 may include one or more processors 117 coupled to memory 119. The server 115 may be configured as a central system, server or platform to control and call various data at different times to execute a plurality of workflow actions. The server 115 may be configured to connect to any component of system 100 via network 110. The server 115 may be in data communication with the processor 102. For example, a server 115 may be in data communication with apparatus 105 via one or more networks 110. The apparatus 105 may transmit one or more requests to the server 115. The one or more requests may be associated with retrieving data from the server 115. The server 115 may receive the one or more requests from any component of apparatus 105. Based on the one or more requests from, for example the processor 102, the server 115 may be configured to retrieve the requested data. The server 115 may be configured to transmit the received data to the processor 102, the received data being responsive to one or more requests.

In some examples, the server 115 can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a server 115, it is understood that other embodiments can use multiple servers or multiple computer systems as necessary or desired to support the users and can also use back-up or redundant servers to prevent network downtime in the event of a failure of a particular server.

The server 115 may include an application comprising instructions for execution thereon. For example, the application may reside in memory 119 of server 115 and may comprise instructions for execution on the server 115. The application of the server 115 may be in communication with any components of system 100. For example, server 115 may execute one or more applications that enable, for example, network and/or data communications with one or more components of system 100 and transmit and/or receive data. Without limitation, the server 115 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The server 115 also may be a mobile device; for example, a mobile device may include an iPhone, iPod, iPad from Apple® or any other mobile device running Apple's iOS® operating system, any device running Microsoft's Windows® Mobile operating system, any device running Google' s Android® operating system, and/or any other smartphone, tablet, or like wearable mobile device.

The server 115 may include processing circuitry and may contain additional components, including processors, memories, error and parity/CRC checkers, data encoders, anticollision algorithms, controllers, command decoders, security primitives and tamperproofing hardware, as necessary to perform the functions described herein. The server 115 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include one or more databases 120. The database 120 may comprise a relational database, a non-relational database, or other database implementations, and any combination thereof, including a plurality of relational databases and non-relational databases. In some examples, the database 120 may comprise a desktop database, a mobile database, or an in-memory database. Further, the database 120 may be hosted internally by any component of system 100, such as the apparatus 105 or server 115, or the database 120 may be hosted externally to any component of the system 100, such as the apparatus 105 or server 115, by a cloud-based platform, or in any storage device that is in data communication with the apparatus 105 and server 115. In some examples, the database 120 may be in data communication with any number of components of system 100. For example, the server 115 may be configured to retrieve the requested data from the database 120 that is transmitted by the processor 102. Server 115 may be configured to transmit the received data from database 120 to the processor 102 via network 110, the received data being responsive to the transmitted one or more requests. In other examples, the processor 102 may be configured to transmit one or more requests for the requested data from database 120 via network 110.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the apparatus 105, server 115, and/or database 120, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein.

FIGS. 2A-2C illustrate a card 200. Although FIG. 2A-2C illustrate single instances of components of card 200, any number of components may be utilized.

Card 200 may be configured to communicate with one or more components of system 100. Card 200 may comprise a contact-based card (e.g., a card read by a swipe of a magnetic stripe or by insertion into a chip reader) or a contactless card, and the card 200 may comprise a payment card, such as a credit card, debit card, or gift card. As shown in FIG. 2A, the card 200 may be issued by a service provider designation 205 displayed on the front of the card 200 (and/or on the back of the card 200, as shown in FIG. 2C). In some examples, the card 200 is not related to a payment card, and may comprise, without limitation, an identification card, a membership card, and a transportation card. In some examples, the payment card may comprise a dual interface contactless payment card.

Card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the card 200 may have physical characteristics compliant with the ID-1 format of the ISO/IEC 7810 standard, and the card 200 may otherwise be compliant with the ISO/IEC 14443 standard. However, it is understood that the card 200 according to the present disclosure may have different characteristics, and the present disclosure does not require implementation in a payment card.

The card 200 may also include identification information 215 displayed on the front and/or back of the card, and the card 200 may also include a contact pad 220. The contact pad 220 may be configured to establish contact with another communication device, including but not limited to a user device, smartphone, laptop, desktop, or tablet computer. The card 200 may also include processing circuitry, antenna and other components not shown in FIG. 2A. These components may be located behind the contact pad 220 or elsewhere on the substrate 210. The card 200 may also include a magnetic strip or tape 260, which may be located on the back of the card (shown in FIG. 2C).

The service provider designation 205 may include the name and logo of the service provider, and may also include information relating to the service provider, including without limitation a telephone number, electronic, internet or physical addresses, instructions for handling the card 200 if has been lost or damaged, and other information. The service provider designation 205 may also include an image or graphical design.

The identification information 215 may include, without limitation, an account number, a name, an expiration date, a phone number, a nickname, an internet address, a security code, a sequence number, payment network, a barcode, and other information. In some examples, the identification information 215 may further include an image or graphical design. For example, the identification information 215 may include an image of the user, a picture, a drawing, or a logo.

As illustrated in FIG. 2B, the contact pad 220 of FIG. 2A may include processing circuitry 225 for storing and processing information, including a processor 230, such as a microprocessor, and a memory 235. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 235 may be a read-only memory, write-once read-multiple memory or read/write memory, e.g., RAM, ROM, and EEPROM, and the card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 235 may be configured to store one or more applets 240, one or more counters 245, and a customer identifier 250. The one or more applets 240 may comprise one or more software applications configured to execute on one or more contact-based or contactless cards, such as Java Card applet. However, it is understood that applets 240 are not limited to Java Card applets, and instead may be any software application operable on contact-based or contactless cards or other devices having limited memory. The one or more counters 245 may comprise a numeric counter sufficient to store an integer. The customer identifier 250 may comprise a unique alphanumeric identifier assigned to a user of the card 200, and the identifier may distinguish the user of the contactless card from other contactless card users. In some examples, the customer identifier 250 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the contact pad 220 or entirely separate from it, or as further elements in addition to processor 230 and memory 235 elements located within the contact pad 220.

In some examples, the card 200 may comprise one or more antennas 255. The one or more antennas 255 may be placed within the card 200 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of card 200 may act as the secondary of an air core transformer. The terminal may communicate with the card 200 by cutting power or amplitude modulation. The card 200 may infer the data transmitted from the terminal using the gaps in the card's power connection, which may be functionally maintained through one or more capacitors. The card 200 may communicate back by switching a load on the card's coil or load modulation. Load modulation may be detected in the terminal's coil through interference.

As illustrated in FIG. 2C, the card 200 may include a service provider designation 205 and identification information 215. The card 200 may further include a magnetic strip or tape 260.

The service provider designation 205 identification information 215 of card 200 may be embossed or printed onto the card 200 by an embosser or a printer, as described herein. In some examples, the magnetic strip or tape 260 may also be embossed or printed on the card 200 by the embosser or printer. The ribbon used may be shredded by the shredding unit, and collected by the collection unit, as described herein. In some examples, the ribbon must be fully utilized prior to shredding and collection. In other examples, the ribbon may be partially utilized prior to shredding and collection. In some examples, the secure destruction and collection of the ribbon waste is applicable to colored or metallic tipping foils that are used to embellish any embossed or printed identifiers, symbols, numbers, and/or characters.

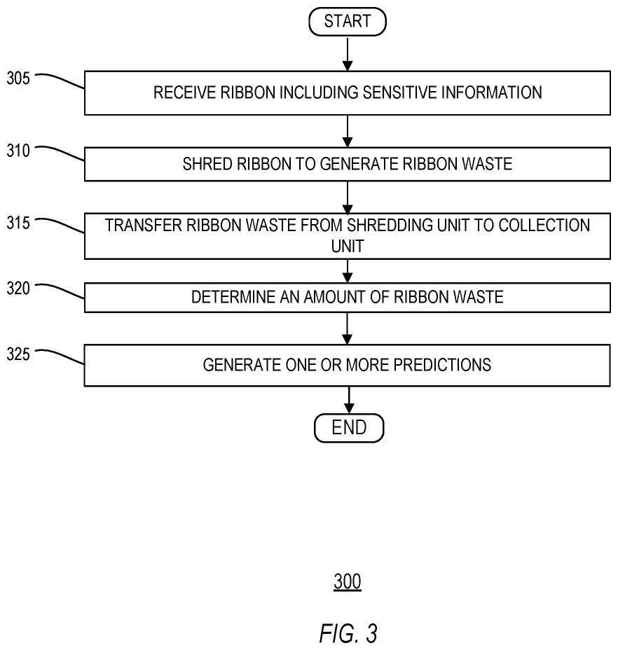

FIG. 3 depicts a method 300 of secure card printing ribbon removal. FIG. 3 may reference the same or similar components of system 100, and card 200 of FIG. 2A and FIG. 2B and FIG. 2C.

At block 305, the method may include receiving ribbon including sensitive information. For example, a shredding unit may be configured to receive ribbon including sensitive information. The shredding unit may comprise a micro-shredder. The micro-shredder may be compliant with, for example, shredding security level DIN Level-P5 or higher, in relation to the size of the shredded particles. The card printing ribbon may comprise material including sensitive information. The sensitive information may comprise non-public personal information such as, but not limited to, account number, date of birth, name information, expiration date, identifiers, and the like. Without limitation, the card may comprise an identification card, a temporary or permanent access card, a security card, a gift card, a debit card, a credit card, prepaid cards, insurance cards. In some examples, the shredding unit may be configured to receive the card printing ribbon via one or more spools. The one or more spools may be configured to convey the card printing ribbon via a belt to the shredding unit. The one or more spools may be configured to convey the card printing ribbon via a set of rollers to the shredding unit, which may include, by way of example, one or more spring-loaded tensioners or tractor feed pins.

At block 310, the method may include shredding the ribbon to generate ribbon waste. For example, the shredding unit may be configured to shred card printing ribbon and generate ribbon waste. Prior to shredding of the card printing ribbon, the shredding unit may be configured to shred this material only after the ribbon has been fully utilized. In other examples, the shredding unit may be configured to shred the card printing ribbon after it has been partially utilized. The card printing ribbon may be shredded by the shredding unit such that the remainder particles are small enough and compliant with rules governing the shredding size. It is understood that different types of printing methods may be applicable to the card, including but not limited to dye sublimation and thermal transfer printing.

At block 315, the method may include transferring the ribbon waste from a shredding unit to a collection unit. For example, the shredding unit may transfer the generated ribbon waste to the collection unit. The collection unit may be attached to the shredding unit. In some examples, the collection unit may be positioned under the shredding unit. In addition, the collection unit may be coupled to the shredding unit. The apparatus may include the shredding unit and the collection unit. For example, the apparatus may comprise a printer apparatus that is configured to print information onto a card. In another example, the apparatus may comprise an embosser that is configured to emboss information onto a card and embellish the embossed information with a colored or metallic foil via tipping. In yet another example, the apparatus may comprise a printer and an embosser that are integrated therein and configured to perform these functions. In some examples, the collection unit may be engaged to the shredding unit. In other examples, the collection unit may be sealed to the shredding unit.

At block 320, the method may include determining an amount of ribbon waste. For example, the collection unit may include a sensor. In some examples, the sensor may be configured to determine the amount of ribbon waste contained in the collection unit. The sensor may be configured to determine that the amount of ribbon waste exceeds a threshold amount. For example, the threshold amount may be controlled by a processor. The sensor may be configured to determine a fill level in the collection unit based on weight of the ribbon waste.

In some examples, the threshold amount may correspond to the visual fill line. Upon determination that the amount of ribbon waste exceeds the threshold amount, the sensor may be configured to generate one or more signals. For example, at least one of the signals may indicate the amount of ribbon waste. The signal may further indicate when to remove the second unit. For example, the signal may further indicate, upon the ribbon waste reaching the visual fill line of the collection unit, removal of the collection unit to empty the ribbon waste.

At block 325, the method may include generating one or more predictions. For example, when the collection unit is full, the signal may trigger an alert via an interface, such as the communication interface on the apparatus. The apparatus may be configured to enter a non-operational or inactive state in which the collection unit must be emptied and sensor reset prior to resuming or continuing normal operation. In some examples, the processor of the apparatus may be configured to control the shredding unit and/or the collection unit. In some examples, the processor may be configured to operate the shredding unit and the collection unit. The processor may thus be in data communication with the sensor of the second unit. The processor may be configured to receive the one or more signals generated by the sensor of the collection unit. Based on the received signal, the processor may be configured to generate a prediction of a remaining capacity of the collection unit by applying one or more predictive models. For example, the remaining capacity may comprise the amount of remaining ribbon waste in the collection unit as determined by the processor. In some examples, the processor may be configured to activate a latch based on the one or more signals. For example, the processor may be configured to disengage the latch when the signal indicates the remaining capacity of the collection unit has met or exceeded a predetermined threshold amount of ribbon waste. In this manner, the collection unit may be automatically unsecured by the processor. In another example, the processor may be configured to re-engage the latch when the collection unit has been emptied after having met or exceeded a predetermined threshold amount of ribbon waste, and the collection unit is brought back to the apparatus for re-attachment. In this manner, the collection unit may be automatically secured by the processor.

The processor may be configured to monitor the amount of waste. For example, the processor may be configured to monitor an amount of ribbon waste in the collection unit. The processor may be configured to periodically obtain measurements from the sensor at a predetermined time or schedule. Based on the monitored amount, the processor may be configured to generate one or more predictions on when to empty the collection unit. For example, the processor may be configured to generate a prediction based on one or more variables. Without limitation, the one or more variables may include the amount of time the apparatus has been operating, such as the amount of time the shredding unit has been shredding the card ribbon and/or the amount of time the collection unit has been accumulating the card ribbon waste; the type of card ribbon; the anticipated workload of card ribbon; the amount of unused ribbon remaining on one or more spools; the number of cards processed against one or more spools of ribbon; a desired frequency of shredding; a desired frequency of disposal; and/or any combination thereof.

The one or more predictions by the processor may be developed by one or more machine learning algorithms and generated by the application of by one or more predictive models. In an embodiment, the machine learning algorithms employed can include at least one selected from the group of gradient boosting machine, logistic regression, neural networks, and a combination thereof, however, it is understood that other machine learning algorithms can be utilized.

For example, to generate predictions, one or more predictive models may utilize information relating to the variables described above, including without limitation: the amount of time the apparatus has been operating; the amount of time the shredding unit has been shredding the card ribbon; the amount of time the collection unit has been accumulating the card ribbon waste; the type of card ribbon; the anticipated workload of card ribbon; the amount of unused ribbon remaining on one or more spools; the number of cards processed against one or more spools of ribbon; a desired frequency of shredding; a desired frequency of disposal; the type of ribbon currently being used; one or more types of ribbon previously used; and one or more types of ribbons anticipated or planned to be used. The predictive models described herein may utilize various neural networks, such as CNNs or RNNs, to generate exemplary models.

The predictive models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems.

In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

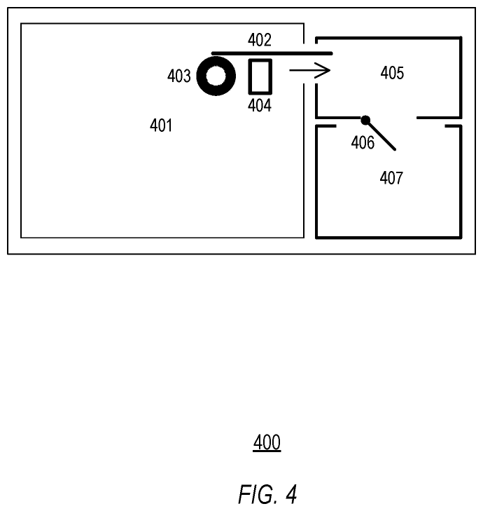

FIG. 4 depicts an apparatus 400 according to an exemplary embodiment. FIG. 4 may reference the same or similar components of system 100, card 200 of FIG. 2A and FIG. 2B, and method 300 of FIG. 3. The apparatus 400 may include a printer and embosser 401, a ribbon 402, a spool 403, a heating element 404, a shredding unit 405, a latch 406, and a collection unit 407.

The apparatus 400 may include a printer and embosser 401. For example, the apparatus 400 may comprise a printer that is configured to print information using the ribbon 402 onto a card. In another example, the apparatus 400 may comprise an embosser that is configured to emboss information onto a card and use the ribbon 402 to embellish the embossed information via tipping. In yet another example, the apparatus 400 may comprise a printer and an embosser 401 that are integrated therein and configured to perform these functions.

The apparatus 400 may include ribbon 402. For example, the ribbon 402 may include card printing ribbon, and may comprise material including sensitive information. The sensitive information may comprise non-public personal information such as, but not limited to, account number, date of birth, name information, expiration date, identifiers, and the like. Without limitation, the card, in which the ribbon 402 is printed or embossed on, may comprise an identification card, a temporary or permanent access card, a security card, a gift card, a debit card, a credit card, prepaid cards, insurance cards.

The apparatus 400 may include a spool 403. The spool 403 may be configured to store and dispense the unused ribbon 402 during the printing and tipping processes.

The apparatus 400 may include a heating element 404, which may have a platen or a thermal print head. As ribbon is passed over the substrate, the heating element may be configured to create appropriate sufficient amount of heat to transfer the ribbon's ink, wax or foil to the substrate.

The apparatus 400 may include a shredding unit 405. The shredding unit 405 may comprise a micro-shredder. The micro-shredder may be compliant with, for example, shredding security level DIN Level-P5 or higher, in relation to the size of the remainder particles. The shredding unit 405 may be configured to shred card printing ribbon 402 and generate ribbon waste. In some examples, the shredding unit 405 may be configured to receive the card printing ribbon 402 via one or more spools 403 from the apparatus 400. The spool 403 may be configured to convey the card printing ribbon 402 via a belt or other conveying mechanism to the shredding unit 405, as illustrated in FIG. 4. The spool 403 may be configured to convey the card printing ribbon via a set of rollers to the shredding unit 405, which may include, by way of example, one or more spring-loaded tensioners or tractor feed pins. The shredding unit 405 may further comprise a latch 406.

The apparatus 400 may include a collection unit 407. The collection unit 407 may be configured to receive the ribbon 402 from the shredding unit 405. The collection unit 407 may be attached to the shredding unit 405. In some examples, the collection unit 407 may be positioned under the shredding unit 405. In addition, the collection unit 407 may be coupled to the shredding unit 405 and can be a separate unit from the printer and embosser 401. In some examples, the collection unit 407 may be engaged to the shredding unit 405. In other examples, the collection unit 407 may be sealed to the shredding unit 405 and/or form a component of the shredding unit 405. The collection unit 407 may be removably attached to the shredding unit 405 via a latch 406, as described below.

The processor may be configured to control the shredding unit 405 and collection unit 407. In some examples, the shredding unit 405 may further comprise the latch 406. The latch 406 may include a spring-loaded latch that is disposed in one or more positions based on the collection unit 407. For example, the latch 406 may, upon removal of the collection unit 407, close. In another example, the latch 406 may, upon re-attachment of the collection unit 407 to the shredding unit 405, open. The latch 406 may be controlled by a processor of the apparatus 400.

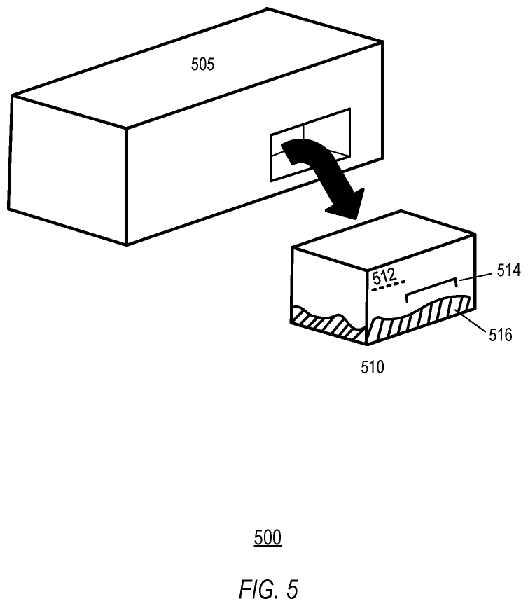

FIG. 5 depicts an apparatus 500 according to an exemplary embodiment. FIG. 5 may reference the same or similar components of system 100, card 200 of FIG. 2A and FIG. 2B and FIG. 2C, method 300 of FIG. 3, and apparatus 500 of FIG. 4. The apparatus 500 may include a printer and embosser 505, and a collection unit 510. The collection unit 510 may include a visual fill line 512, a handle 514, and ribbon waste 516.

The apparatus 500 may include a printer and embosser 505. For example, the apparatus 500 may comprise a printer that is configured to print information using the ribbon onto a card. In another example, the apparatus 500 may comprise an embosser 505 that is configured to emboss information onto a card and embellish the embossed information with a colored or metallic foil via tipping. In yet another example, the apparatus 500 may comprise a printer and an embosser 505 that are integrated therein and configured to perform these functions.

The collection unit 510 may be detached from the printer and embosser 505, as indicated in FIG. 5, for removal of the contents of the ribbon waste inside collection unit 510. Subsequently, the collection unit 510 may be re-attached to the printer and embosser 505 after removal of the contents of the ribbon waste 516 inside collection unit 510. As previously discussed the ribbon waste 516 may be generated by a shredding unit and deposited thereafter in the collection unit 510.

The collection unit 510 may include one or more fill lines 512. The one or more fill lines 512 may include one or more visual fill lines. Without limitation, the visual fill line may be associated with any character, image, identifier, symbol, number, and/or any combination thereof for any range regarding the amount of ribbon waste 516. For example, the visual fill line may comprise a first line indicating “half” for halfway capacity of the collection unit, and a second line indicating “full” for full capacity of the collection unit. In another example, the visual fill line may comprise a first line indicating “33%”, a second line indicating “66%”, and a third line indicating “100%”. In another example, the visual fill line may comprise a line indicating “F” for full capacity of the collection unit 510. In some examples, a threshold amount of ribbon waste 516 may correspond to the visual fill line. Upon determination that the amount of ribbon waste 516 exceeds the threshold amount, the collection unit 510 may be configured to generate one or more signals. For example, at least one of the signals may indicate the amount of ribbon waste 516. The signal may further indicate when to remove the collection unit 510 from the printer and embosser 505. For example, the signal may further indicate, upon the ribbon waste reaching the visual fill line of the collection unit, removal of the collection unit to empty the ribbon waste 516.

The collection unit 510 may include a handle 514. For example, the collection unit 510 may include a handle 514 coupled thereto so as to assist in removal from the printer and embosser 505. For removal of the collection unit 510, any amount of ribbon waste 516 may be contained therein for removal via handle 514. Without limitation, the handle 514 may comprise a grip of any shape, such as an arc shape or a u-shape, and include material of any plastic, metallic, or any combination thereof.

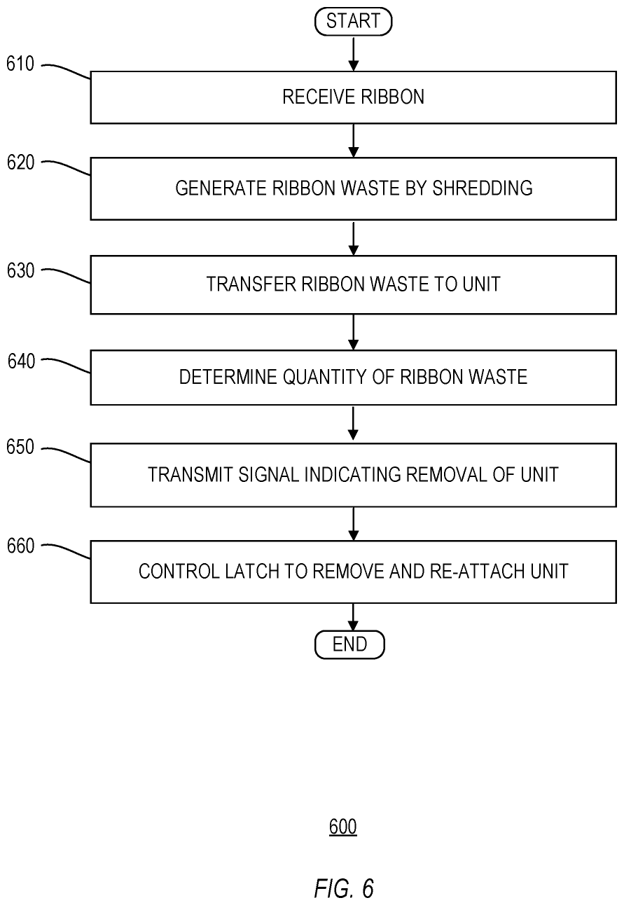

FIG. 6 depicts a method 600 of a method of secure card printing ribbon removal according to an exemplary embodiment. FIG. 6 may reference the same or similar components of system 100, card 200 of FIG. 2A and FIG. 2B and FIG. 2C, method 300 of FIG. 3, apparatus 400 of FIG. 4, and apparatus 500 of FIG. 5.

At block 610, the method may include receiving ribbon. For example, a shredding unit may be configured to receive ribbon including sensitive information. The shredding unit may comprise a micro-shredder. The micro-shredder may be compliant with, for example, shredding security level DIN Level-P5 or higher, in relation to the size of the shredded particles. The card printing ribbon may comprise material including sensitive information. The sensitive information may comprise non-public personal information such as, but not limited to, account number, date of birth, name information, expiration date, identifiers, and the like. Without limitation, the card may comprise an identification card, a temporary or permanent access card, a security card, a gift card, a debit card, a credit card, prepaid cards, insurance cards. In some examples, the shredding unit may be configured to receive the card printing ribbon via one or more spools. The one or more spools may be configured to convey the card printing ribbon via a belt to the shredding unit.

At block 620, the method may include generating ribbon waste by shredding the ribbon. For example, the shredding unit may be configured to shred card printing ribbon and generate ribbon waste. Prior to shredding of the card printing ribbon, the shredding unit may be configured to shred this material only after the ribbon has been fully utilized. In other examples, the shredding unit may be configured to shred the card printing ribbon after it has been partially utilized. The card printing ribbon may be shredded by the shredding unit such that the remainder particles are small enough and compliant with rules governing the shredding size. It is understood that different types of printing methods may be applicable to the card, including but not limited to dye sublimation and thermal transfer printing.

At block 630, the method may include transferring the ribbon waste to a unit. For example, the unit may comprise a collection unit. For example, the shredding unit may transfer the generated ribbon waste to the collection unit. The collection unit may be attached to the shredding unit. In some examples, the collection unit may be positioned under the shredding unit. In addition, the collection unit may be coupled to the shredding unit. The apparatus may include the shredding unit and the collection unit. For example, the apparatus may comprise a printer apparatus that is configured to print information onto a card. In another example, the apparatus may comprise an embosser that is configured to emboss information onto a card and embellish the embossed information with a colored or metallic foil via tipping. In yet another example, the apparatus may comprise a printer and an embosser that are integrated therein and configured to perform these functions. In some examples, the collection unit may be engaged to the shredding unit. In other examples, the collection unit may be sealed to the shredding unit.

At block 640, the method may include determining a quantity of ribbon waste. For example, the collection unit may include a sensor. In some examples, the sensor may be configured to determine the amount of ribbon waste contained in the collection unit. The sensor may be configured to determine that the amount of ribbon waste exceeds a threshold amount. For example, the threshold amount may be controlled by a processor of an apparatus that houses the shredding and collection units.

At block 650, the method may include transmitting a signal indicating removal of unit. For example, the sensor may generate and transmit a signal upon determination that the amount of ribbon waste exceeds the threshold amount, the sensor may be configured to generate one or more signals. In some examples, the threshold amount may correspond to the visual fill line. For example, at least one of the signals may indicate the amount of ribbon waste. The signal may further indicate when to remove the collection unit. For example, the signal may further indicate, upon the ribbon waste reaching the visual fill line of the collection unit, removal of the collection unit to empty the ribbon waste.

At block 660, the method may include controlling a latch to remove and re-attach the unit. For example, a latch may be controlled by the processor to engage or disengage the collection unit from the shredding unit. The processor may be configured to receive the one or more signals generated by the sensor of the collection unit. Based on the received signal, the processor may be configured to generate a prediction of a remaining capacity of the collection unit. For example, the remaining capacity may comprise the amount of remaining ribbon waste in the collection unit as determined by the processor. In some examples, the processor may be configured to activate a latch based on the one or more signals. For example, the processor may be configured to disengage the latch when the signal indicates the remaining capacity of the collection unit has met or exceeded a predetermined threshold amount of ribbon waste. In this manner, the collection unit may be automatically unsecured by the processor. In another example, the processor may be configured to re-engage the latch when the collection unit has been emptied after having met or exceeded a predetermined threshold amount of ribbon waste, and the collection unit is brought back to the apparatus for re-attachment to the shredding unit. In this manner, the collection unit may be automatically secured by the processor.

The processor may be configured to monitor the amount of waste. For example, the processor may be configured to monitor an amount of ribbon waste in the collection unit. The processor may be configured to periodically obtain measurements from the sensor at a predetermined time or schedule. Based on the monitored amount, the processor may be configured to generate one or more predictions on when to empty the collection unit. For example, the processor may be configured to generate a prediction based on one or more variables. Without limitation, the one or more variables may include the amount of time the apparatus has been operating, such as the amount of time the shredding unit has been shredding the card ribbon and/or the amount of time the collection unit has been accumulating the card ribbon waste; the type of card ribbon; the anticipated workload of card ribbon; the amount of unused ribbon remaining on one or more spools; the number of cards processed against one or more spools of ribbon; a desired frequency of shredding; a desired frequency of disposal; and/or any combination thereof.

The one or more predictions by the processor may be developed by one or more machine learning algorithms and generated by the application of by one or more predictive models. In an embodiment, the machine learning algorithms employed can include at least one selected from the group of gradient boosting machine, logistic regression, neural networks, and a combination thereof, however, it is understood that other machine learning algorithms can be utilized.

For example, to generate predictions, one or more predictive models may utilize information relating to the variables described above, including without limitation: the amount of time the apparatus has been operating; the amount of time the shredding unit has been shredding the card ribbon; the amount of time the collection unit has been accumulating the card ribbon waste; the type of card ribbon; the anticipated workload of card ribbon; the amount of unused ribbon remaining on one or more spools; the number of cards processed against one or more spools of ribbon; a desired frequency of shredding; a desired frequency of disposal; the type of ribbon currently being used; one or more types of ribbon previously used; and one or more types of ribbons anticipated or planned to be used. The predictive models described herein may utilize various neural networks, such as CNNs or recurrent neural networks RNNs, to generate exemplary models.

The predictive models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

The instant specification refers to ribbon used for printing, however, the present disclosure is not limited thereto. Rather, the present disclosure includes the secure destruction and collection of other types of printing waste as well, including colored or metallic tipping foils used to embellish embossed identifiers, symbols, numbers, and/or characters.

The instant specification refers to printing information on cards, however, the present disclosure is not limited to a particular type of card or to printing on a particular type of medium. The present disclosure includes printing information on a variety of cards, including without limitation payment cards (e.g., credit cards, debit cards, gift cards), identity cards (e.g., driver's licenses, passports, travel cards), insurance cards, access cards, badges, security cards, membership cards, promotional cards, transportation cards, and loyalty cards. The present disclosure further includes printing information on a variety of mediums, including without limitation cards, papers, flyers, brochures, pamphlets, books, magazines, plaques, medals, and certificates.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A secure card printing ribbon removal system, comprising:
a shredding unit configured to shred card printing ribbon and generate ribbon waste;
a collection unit removably attached to the shredding unit and configured to receive ribbon waste from the shredding unit, wherein the collection unit comprises:
a transparent material,
a visual fill line, and
a sensor configured to determine the amount of ribbon waste contained in the collection unit and, upon determination that the amount of ribbon waste exceeds a threshold, generate a signal; and
a processor that is configured to:
operate the shredding unit and the collection unit,
receive the signal generated by the collection unit, and
generate, based on the signal, a prediction of a remaining capacity of the collection unit,
wherein the ribbon comprises material containing sensitive information.

2. The secure card printing ribbon removal system of claim 1, wherein the shredding unit and the removable collection unit share a common power source.

3. The secure card printing ribbon removal system of claim 1, wherein the threshold corresponds to the visual fill line.

4. The secure card printing ribbon removal system of claim 1, wherein the signal indicates the amount of ribbon waste.

5. The secure card printing ribbon removal system of claim 4, wherein the signal further indicates, upon the ribbon waste reaching the visual fill line, removal of the collection unit to empty the ribbon waste.

6. The secure card printing ribbon removal system of claim 5, wherein the shredding unit includes a latch that, upon removal of the removable collection unit, closes.

7. The secure card printing ribbon removal system of claim 6, wherein the latch, upon re-attachment of the removable collection unit to the shredding unit, opens.

8. The secure card printing ribbon removal system of claim 1, wherein the shredding unit and the removable collection unit are securely housed in an apparatus.

9. The secure card printing ribbon removal system of claim 1, wherein the ribbon is fully utilized prior to shredding by the shredding unit.

10. The secure card printing ribbon removal system of claim 1, wherein the processor is further configured to monitor an amount of ribbon waste, and generate one or more predictions based on the monitored amount by applying a predictive model, the one or more predictions indicative of when to empty the removable collection unit.

11. A method of secure card printing ribbon removal comprising:
receiving ribbon, wherein the ribbon comprises material including sensitive information associated with one or more card printing methods;
shredding the ribbon to generate ribbon waste;
transferring the ribbon waste from a shredding unit to a collection unit;
determining an amount of ribbon waste; and
generating, based on the determined amount of ribbon waste, one or more predictions, the one or more predictions indicative of when to empty the collection unit.

12. The method of claim 11, wherein the shredding unit and the collection unit share a common power source.

13. The method of claim 11, wherein the ribbon is fully utilized prior to shredding by the shredding unit.

14. The method of claim 11, further comprising transmitting, upon determination of the amount of ribbon waste that is received at the collection unit, a signal that indicates the amount of ribbon waste.

15. The method of claim 14, wherein the signal further indicates, upon the ribbon waste reaching a threshold level of a visual fill line of the collection unit, removal of the collection unit to empty the ribbon waste.

16. The method of claim 11, further comprising closing, upon removal of the collection unit, a latch of the shredding unit.

17. The method of claim 16, further comprising opening, upon re-attachment of the collection unit to the shredding unit, the latch.

18. The method of claim 11, wherein the shredding unit and the removable collection unit are securely housed in an apparatus.

19. The method of claim 11, further comprising sensing the amount of ribbon waste in the collection unit in relation to a threshold amount.

20. A non-transitory computer-accessible medium having stored thereon computer-executable instructions, wherein upon execution by a processor, the instructions cause the processor to perform procedures comprising:
receiving ribbon;
shredding the ribbon to generate ribbon waste, wherein the ribbon waste comprises material including sensitive information associated with one or more card printing methods;
transferring the ribbon waste from a shredding unit to a collection unit;
determining an amount of ribbon waste; and
applying a predictive model to generate, based on the determined amount of ribbon waste, one or more predictions, the one or more predictions indicative of when to empty the collection unit.
